(19) United States
(12) Patent Application Publication
(10) Pub. No.: US 2010/0287546 A1
(43) Pub. Date: Nov. 11, 2010

(54) PROGRAM INSTALLING METHOD, NETWORK SYSTEM, AND COMPUTER PROGRAM STORED MEDIUM

(75) Inventor: Yuzo Harano, Sagamihara-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/772,898

(22) Filed: May 3, 2010

(30) Foreign Application Priority Data
May 7, 2009 (JP) 2009-113009(PAT.)

(51) Int. Cl. G06F 9/445

(52) U.S. Cl. 717/176

(57) ABSTRACT

A program installing method is provided which installs a program for controlling an operation of one of a first apparatus and a second apparatus connected through a local network into an information processing apparatus which communicates with the first apparatus and the second apparatus through a different, global network. The method inquires of the first apparatus having an address designated by a user as a control target by the program about whether or not the address is correct from the information processing apparatus. The method then discriminates whether or not a program to be installed can control the first apparatus in response to the inquiry. If it is discriminated that the program cannot control the first apparatus, the method notifies that the designated address is wrong based on information indicative of a discrimination result.

### BACKGROUND OF THE INVENTION

1. Field of the Invention

The present invention relates to a program installing method, a network system, and a computer program and, more particularly, the invention is suitable when it is used to install a program.

2. Description of the Related Art

In the related art, there is an image forming apparatus represented by an MFP (Multi-Function Peripheral) serving as a copy, a scan, a FAX (Facsimile), and the like. A print system in the related art is a print system in which an image forming apparatus and an image processing apparatus as a print controller are mutually connected only through a network cable or a print system in which the network cable and a cable for transmitting image data are mutually connected as media. In such a print system, a printer driver for the image processing apparatus is installed into a client computer by using an IP address of the image processing apparatus. After the printer driver was installed, an execution of a printing process is instructed from the client computer to the image forming apparatus. There is a system having such a mechanism that if the printer driver does not correspond to a page description language (PDL) of the image processing apparatus here, the user is promoted to newly install a printer driver suitable for the image processing apparatus (refer to Japanese Patent Application Laid-Open No. 2006-11709). In recent years, there is also such a construction that both of the image processing apparatus and the image forming apparatus are connected to a LAN (Local Area Network) (refer to FIG. 4 of Japanese Patent Application Laid-Open No. 2006-345329) and each of them can process various kinds of page description languages.

Such a construction that each of the image processing apparatus and the image forming apparatus corresponds to various kinds of page description languages and is connected to the LAN exists. Under such an environment, however, when a printer driver of a desired page description language is installed by the client computer on the LAN, there is a case where the user sets an IP address of a different device into the installer. In such a case, the printer driver of the page description language which does not correspond is installed by the image forming apparatus or, contrarily, the printer driver of the page description language which does not correspond is installed by the image processing apparatus. Thus, such a problem that the printing cannot be normally executed or the like occurs. As disclosed in Japanese Patent Application Laid-Open No. 2006-11709, according to the means for solving the problem after the printer driver was installed, there is a case where it is difficult for the user to grasp a solving method of the problem and there is also a case where it takes a time until the problem is solved. Further, there is also a case where it results in waste of print paper, toner, and the like. Particularly, it takes a time to solve the problem for the user who is not familiar with the print system.

### SUMMARY OF THE INVENTION

According to the invention, there is provided a program installing method which installs a program for controlling an operation of one of a first apparatus and a second apparatus connected through a local network into an information processing apparatus which communicates with the first apparatus and the second apparatus through a different, global network. The method comprises an inquiring step of inquiring of the first apparatus having an address designated by a user as a control target by the program about whether or not the address is correct from the information processing apparatus; a discriminating step of discriminating whether or not a program to be installed can control the first apparatus in response to the inquiry; and a notifying step of, if it is discriminated that the program cannot control the first apparatus, notifying that the designated address is wrong based on information indicative of a discrimination result.

Further features of the present invention will become apparent from the following description of exemplary embodiments with reference to the attached drawings.

### BRIEF DESCRIPTION OF THE DRAWINGS

FIG. 1 is a diagram illustrating an example of a whole construction of a print system according to the first embodiment.

FIG. 2 is a diagram illustrating an example of an IP address input display screen.

FIG. 3 is a diagram illustrating an example of an IP address warning display screen.

FIG. 4 is a diagram illustrating another example of an IP address warning display screen.

FIG. 5 is a flowchart for describing an example of the operation of the print system.

FIG. 6 is a diagram illustrating an example of a whole construction of a print system according to the second embodiment.

FIG. 7 is a flowchart for describing an example of the operation of the print system.

FIG. 8 is a diagram illustrating an example of a whole construction of a print system according to the third embodiment.

FIG. 9 is a diagram for describing in detail an example of the operation of a network information transfer unit.

FIG. 10 is a flowchart for describing an example of the operation of the print system.

### DESCRIPTION OF THE EMBODIMENTS

Preferred embodiments of the present invention will now be described in detail in accordance with the accompanying drawings.

### First Embodiment

The first embodiment of the invention will be described in detail hereinbelow with reference to the drawings.

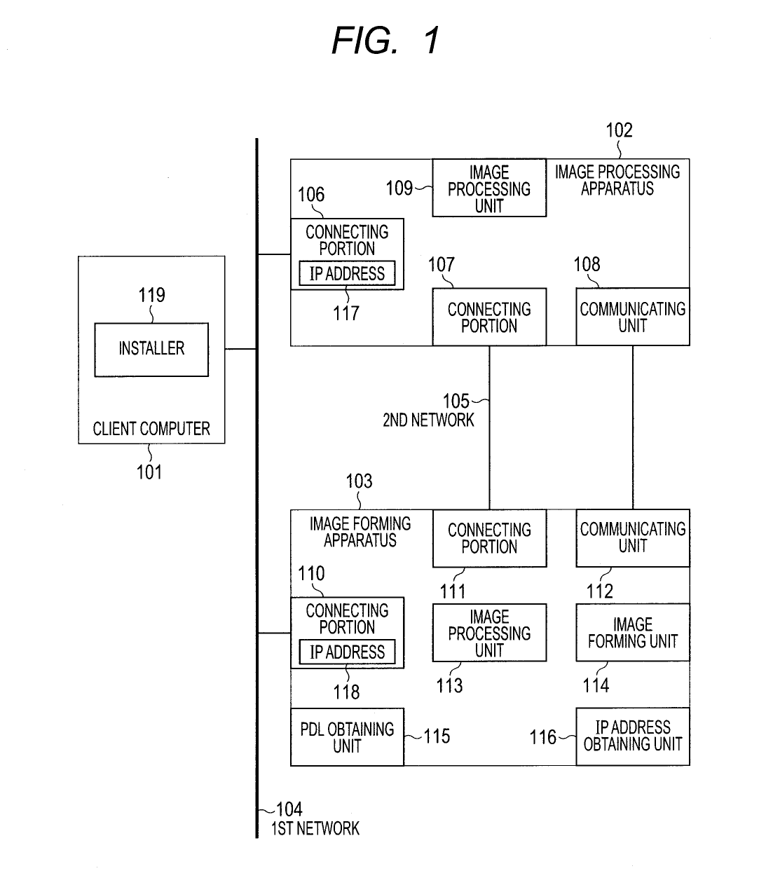

FIG. 1 is a diagram illustrating an example of a whole construction of a print system.

The print system is constructed in such a manner that a client computer 101, an image processing apparatus 102, and an image forming apparatus 103 are mutually connected through a first network 104. The image processing apparatus 102 is mutually connected to the image forming apparatus 103 through a second network 105.

The image processing apparatus 102 has connecting portions 106 and 107, a communicating unit 108, and an image processing unit 109. The embodiment will be described with respect to a case where the image processing apparatus 102 is a print controller (print server) as an example. The connecting portion 106 is a network interface for allowing the image processing apparatus 102 to be connected to the first network 104 and an IP address 117 is allocated. The connecting portion 107 is a network interface for allowing the image processing apparatus 102 to be connected to the second network 105. The communicating unit 108 is a communication medium for transferring image data to the image forming apparatus 103. The image processing unit 109 processes a print job received by the image processing apparatus 102 from the first network 104 and transfers the image data to the image forming apparatus 103 through the second network 105 or the communicating unit 108.

The image forming apparatus 103 has connecting portions 110 and 111, a communicating unit 112, an image processing unit 113, an image forming unit 114, a page description language (PDL) obtaining unit 115, and an IP address obtaining unit 116. The embodiment will be described with respect to a case where the image forming apparatus 103 is a printer as an example. The connecting portion 110 is a network interface for allowing the image forming apparatus 103 to be connected to the first network 104 and an IP address 118 is allocated. The connecting portion 111 is a network interface for allowing the image forming apparatus 103 to be connected to the second network 105. The communicating unit 112 is a communication medium for receiving the image data transferred from the image processing apparatus 102. The image processing unit 113 processes the print job received by the image processing unit 113 from the first network 104. The image forming unit 114 prints the image data sent from the image processing unit 109 of the image processing apparatus 102 or from the image processing unit 113 of the image forming apparatus 103. The PDL obtaining unit 115 obtains information of the page description language (PDL) which can be processed in the image processing unit 109 from the image processing apparatus 102. The page description language (PDL) denotes a language for describing a command for controlling a page printer represented by PS (Post Script) or PCL (Printer Control Language). The IP address obtaining unit 116 obtains the IP address 117 in the first network 104 allocated to the image processing apparatus 102 from the image processing apparatus 102.

The client computer 101 is an information processing apparatus having an installer 119. The embodiment will be described with respect to a case where the client computer 101 is a PC (Personal Computer) as an example. The installer 119 is a program for installing a printer driver for forming a print job including the page description language which can be processed by the image processing unit 109 of the image processing apparatus 102 or by the image processing unit 113 of the image forming apparatus 103 into the client computer 101.

The first network 104 is a global network represented by the Internet or LAN and mutually connects the client computer 101, image processing apparatus 102, and image forming apparatus 103 by network communication represented by a TCP/IP system.

The second network 105 is a local network for mutually connecting the image processing apparatus 102 and the image forming apparatus 103 and mutually connects them by the network communication represented by the TCP/IP system. As mentioned above, the second network 105 is a network for mutually connecting the image processing apparatus 102 and the image forming apparatus 103.

It is assumed that in spite of a fact that the printer driver which the user intends to install is a printer driver for the image processing unit 109, the IP address 118 on the first network 104 allocated to the image forming apparatus 103 has been input to the installer 119. Thus, the image forming apparatus 103 notifies the client computer 101 of a message showing that the IP address 118 which was input to the installer 119 by the user is not correct. Further, the image forming apparatus 103 notifies the installer 119 of the correct IP address, that is, the IP address 117 obtained by the IP address obtaining unit 116 (IP address on the first network 104 allocated to the image processing apparatus 102).

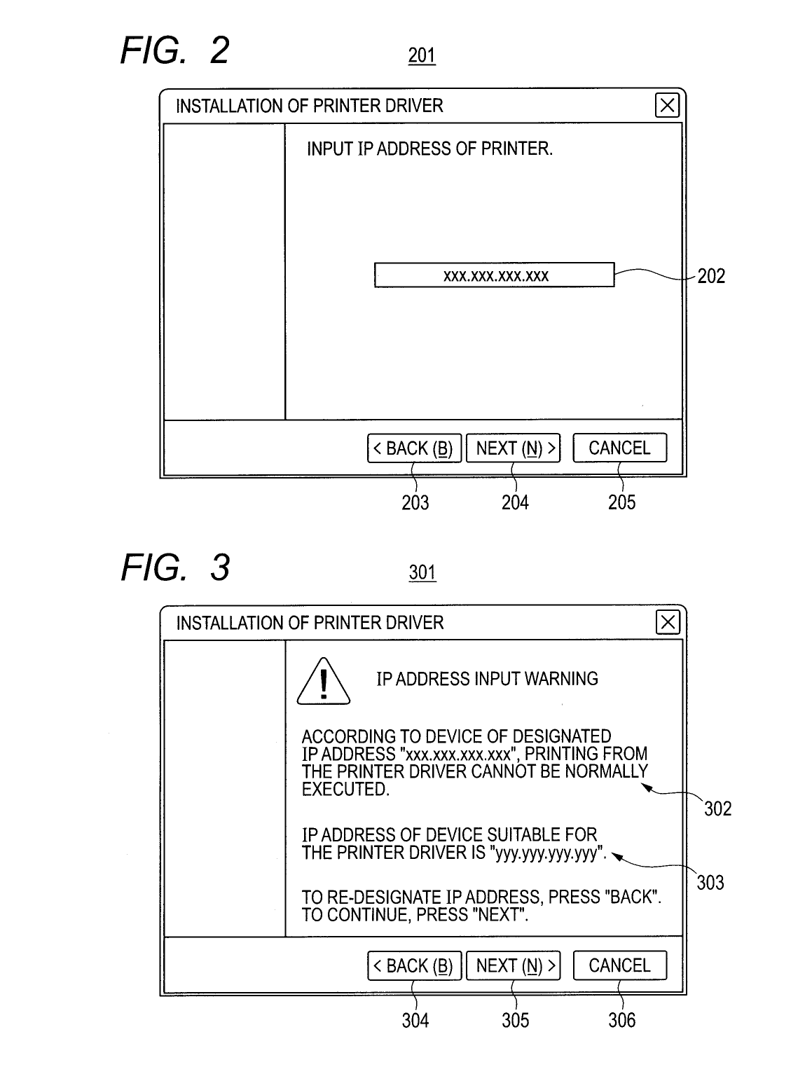

FIG. 2 is a diagram illustrating an example of an IP address input display screen which is displayed by the installer 119 when the user inputs an IP address of a device as a control target of the printer driver into the installer 119 of the printer driver.

“The installer 119 of the printer driver” activated by the operation by the user of the user interface of the client computer 101 displays an IP address input display screen 201 which can input the IP address of a desired device of the user.

An IP address input column 202 is an area where the user inputs the IP address.

When a Back button 203 is pressed by the user, the installer 119 displays a previous display screen of the IP address input display screen 201.

When a Next button 204 is pressed by the user, a process for confirming whether or not the input IP address is correct is executed to the image forming apparatus 103. That is, a process for confirming whether or not the device having the input IP address can normally process the print job which is transmitted from the printer driver that is installed by the installer 119 is executed. If it is determined by the image forming apparatus 103 that the IP address input to the IP address input column 202 of the installer 119 by the user is not correct, the installer 119 displays an IP address warning display screen 301 illustrated in FIG. 3.

When a Cancel button 205 is pressed by the user, the installer 119 finishes the process.

FIG. 3 is a diagram illustrating an example of an IP address warning display screen which is displayed by the installer 119 when the user is notified of a fact that the IP address input to the IP address input display screen 201 of the installer 119 is not correct. In the IP address warning display screen 301, when the correct IP address 117 is informed from the image processing apparatus 102, the IP address 117 is also informed to the user.

The IP address warning display screen 301 is displayed when it is determined by the image forming apparatus 103 that the IP address input to the IP address input column 202 of the installer 119 by the user is not correct.

A message showing that the IP address input by the user is not correct is displayed to a character string 302 as informed from the image forming apparatus 103.

The correct IP address (in this instance, IP address 117) is displayed to a character string 303 as informed from the image forming apparatus 103.

When a Back button 304 is pressed by the user, the installer 119 displays a previous display screen of the IP address warning display screen 301.

When a Next button 305 is pressed by the user, the IP address input to the IP address input column 202 is used and the installer 119 displays a next display screen of the IP address warning display screen 301.

When a Cancel button 306 is pressed by the user, the installer 119 finishes the process.

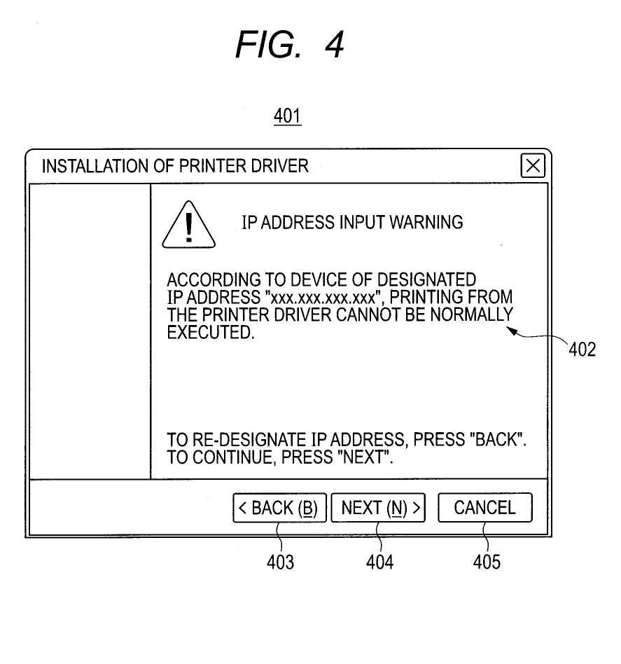

FIG. 4 is a diagram illustrating an example of an IP address warning display screen which is displayed by the installer 119 when it is determined by the image forming apparatus 103 that the printer driver is not suitable for both of the image forming apparatus 103 and the image processing apparatus 102.

A message showing that the IP address 118 input by the user is not correct is displayed to a character string 402 as informed from the image forming apparatus 103.

When a Back button 403 is pressed by the user, the installer 119 displays a previous display screen of an IP address warning display screen 401.

When a Next button 404 is pressed by the user, the IP address input to the IP address input column 202 is used and the installer 119 displays a next display screen of the IP address warning display screen 401.

When a Cancel button 405 is pressed by the user, the installer 119 finishes the process.

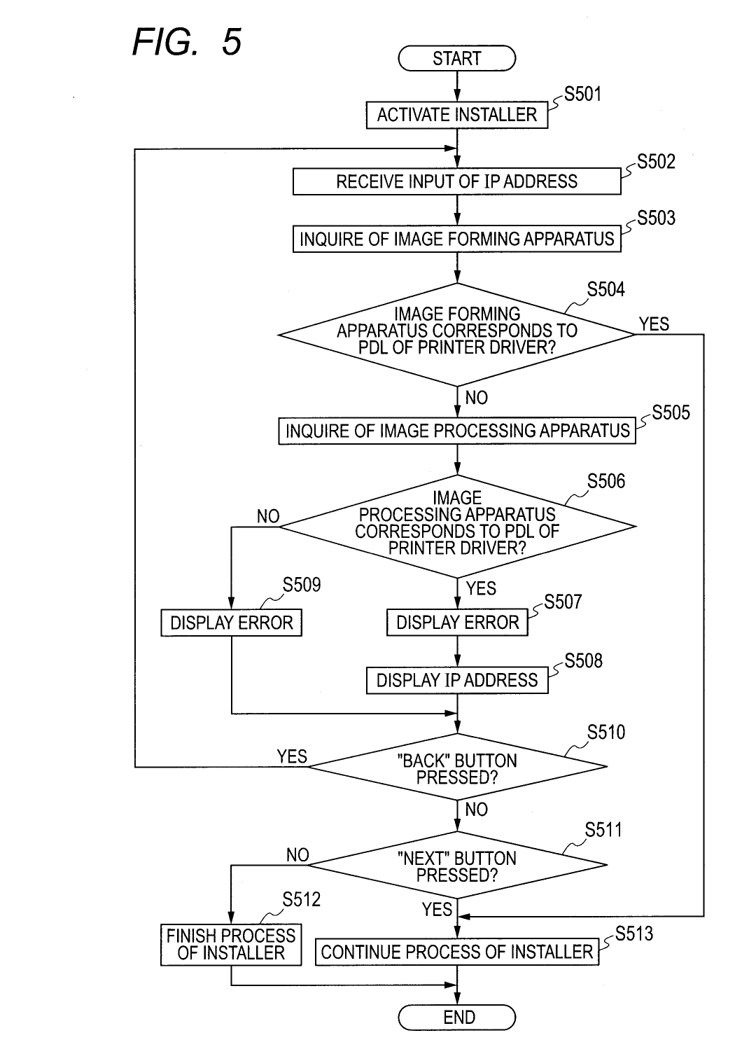

FIG. 5 is a flowchart for describing an example of the operation of the print system.

First, the installer 119 of the printer driver is activated (step S501).

Subsequently, the installer 119 displays the IP address input display screen 201 and receives such an operation that the user inputs the IP address (in this instance, IP address 118) of a desired device corresponding to the printer driver to the IP address input display screen 201 (step S502).

Subsequently, the installer 119 executes a process for transmitting the input IP address 118 through the first network 104 to the image forming apparatus 103 to which the IP address has been allocated. Together with the above process, in order to confirm whether or not the IP address input to the IP address input display screen 201 is correct, the installer 119 inquires about whether or not the image processing unit 113 corresponds to the page description language of the printer driver (step S503).

Subsequently, in response to the inquiry in step S503, the image forming apparatus 103 discriminates whether or not the image processing unit 113 corresponds to the page description language of the printer driver (step S504).

As a result of the discrimination, if the image processing unit 113 of the image forming apparatus 103 corresponds to the page description language of the printer driver, the installer 119 continues the process for installing the printer driver (step S513).

When the image processing unit 113 of the image forming apparatus 103 does not correspond to the page description language of the printer driver, the processing routine advances to step S505. The PDL obtaining unit 115 inquires of the image processing apparatus 102 through, for example, the second network 105 about the page description language which can be processed by the image processing unit 109 of the image processing apparatus 102 (step S505).

Subsequently, based on a response to the inquiry in step S505, the PDL obtaining unit 115 discriminates whether or not the image processing unit 109 of the image processing apparatus 102 corresponds to the page description language of the printer driver (step S506). A response to this discrimination is made, for example, through the second network 105. As a result of the discrimination, if the image processing unit 109 of the image processing apparatus 102 corresponds to the page description language of the printer driver, the installer 119 displays the character string 302 onto the IP address warning display screen 301 (step S507). Subsequently, based on the response to the inquiry in step S505, the installer 119 displays the character string 303 onto the IP address warning display screen 301 (step S508). When the operation by the user is executed to the IP address warning display screen 301, the processing routine advances to step S510, which will be described hereinafter.

If it is determined in step S506 that the image processing unit 109 of the image processing apparatus 102 does not correspond to the page description language of the printer driver, step S509 follows. The installer 119 displays the IP address warning display screen 401 (character string 402) (step S509). When the operation by the user is executed to the IP address warning display screen 401, the processing routine advances to step S510.

In step S510, the installer 119 discriminates whether or not the Back button 304 on the IP address warning display screen 301 or the Back button 403 on the IP address warning display screen 401 has been pressed by the user. As a result of the discrimination, if the Back button 304 or 403 was pressed by the user, the processing routine is returned to step S502 and the installer 119 displays the IP address input display screen 201.

If the Back button 304 or 403 is not pressed by the user, step S511 follows. The installer 119 discriminates whether or not the Next button 305 on the IP address warning display screen 301 or the Next button 404 on the IP address warning display screen 401 has been pressed by the user (step S511). As a result of the discrimination, if the Next button 305 or 404 was pressed by the user, the installer 119 continues the process for installing the printer driver (step S513).

If the Next button 305 or 404 is not pressed by the user, this means that the Cancel button 306 on the IP address warning display screen 301 or the Cancel button 405 on the IP address warning display screen 401 has been pressed by the user. Therefore, the installer 119 stops (finishes) the process for installing the printer driver (step S512).

As mentioned above, in the embodiment, prior to installing the printer driver, the installer 119 inquires of the image forming apparatus 103 corresponding to the IP address designated by the user about whether or not the IP address is correct. When the image processing unit 113 does not correspond to the printer driver, the IP address obtaining unit 116 of the image forming apparatus 103 obtains the IP address of the image processing apparatus 102. The PDL obtaining unit 115 obtains the information of the page description language which can be processed by the image processing unit 109 of the image processing apparatus 102. The image forming apparatus 103 notifies the client computer 101 of those information. The installer 119 which received such a notification informs that there is an error in the IP address which was input by the user (refer to IP address warning display screen 301, 401). Therefore, prior to installing the printer driver, the user can be notified that the input of the IP address is improper. Thus, such a situation that the installation of the printer driver is executed in a state where the user has erroneously input the IP address of the device serving as a target of the print control by the printer driver can be prevented as compared with that in the related art. Consequently, the printer driver can be installed more properly than that in the related art.

In the embodiment, when the printer driver which the user intends to install is a printer driver corresponding to the image processing apparatus 102, the user is notified of the IP address of the image processing apparatus 102 (refer to the character string 303 on the IP address warning display screen 301). Therefore, the user is enabled to certainly input the IP address of the proper device serving as a target of the print control by the printer driver.

In the embodiment, an example of the inquiring step is realized, for example, by executing the process of step S503. An example of the discriminating step is realized, for example, by executing the process of step S504. An example of the first obtaining step and the second obtaining step is realized, for example, by executing the process of step S505. An example of the second discriminating step is realized, for example, by executing the process of step S506. An example of the notifying step is realized, for example, by executing the process of steps S507 to S509.

### Second Embodiment

Subsequently, the second embodiment of the invention will be described. In the foregoing first embodiment, the case where the device designated by the user as a target of the print control by the printer driver is the image forming apparatus 103 has been described as an example. In the second embodiment, on the other hand, a case where the device designated by the user as a target of the print control by the printer driver is the image processing apparatus will be described as an example. As mentioned above, in the first and second embodiments, a part of the process in the case where there is an error in the IP address which was input by the user differs mainly. Therefore, in the following description in the present embodiment, substantially the same portions as those in the first embodiment are designated by the same reference numerals shown in FIGS. 1 to 5 and their detailed description is omitted.

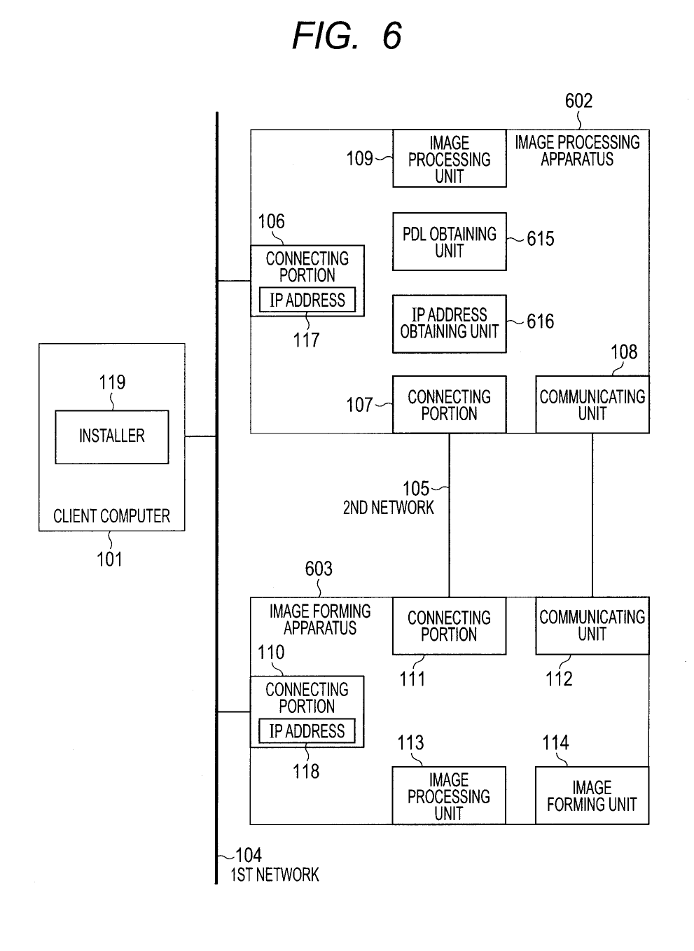

FIG. 6 is a diagram illustrating an example of a whole construction of the print system.

The print system is constructed in such a manner that the client computer 101, an image processing apparatus 602, and an image forming apparatus 603 are mutually connected through the first network 104. The image processing apparatus 602 is mutually connected to the image forming apparatus 603 through the second network 105.

The image processing apparatus 602 has the connecting portions 106 and 107, communicating unit 108, image processing unit 109, a page description language (PDL) obtaining unit 615, and an IP address obtaining unit 616. The embodiment will be described also with respect to a case where the image processing apparatus 602 is a print controller (print server) as an example.

The PDL obtaining unit 615 obtains information of the page description language (PDL) which can be processed in the image processing unit 113 of the image forming apparatus 603 from the image forming apparatus 603. The IP address obtaining unit 616 obtains the IP address 117 in the first network 104 allocated to the image forming apparatus 603 from the image forming apparatus 603.

The image forming apparatus 603 has the connecting portions 110 and 111, communicating unit 112, image processing unit 113, and image forming unit 114. Those units have already been described in the first embodiment. The second embodiment will be described also with respect to a case where the image forming apparatus 603 is a printer as an example.

The client computer 101 is an apparatus having the installer 119. As described in the first embodiment, the installer 119 is a program for installing the printer driver for forming the print job including the page description language which can be processed by the image processing apparatus 102 or the image forming apparatus 103 into the client computer 101.

It is assumed that in spite of a fact that the printer driver which the user intends to install is a printer driver for the image processing unit 113, the IP address 117 on the first network 104 allocated to the image processing apparatus 602 has been input to the installer 119. Thus, the image processing apparatus 602 notifies the client computer 101 of a message showing that the IP address 117 which was input to the installer 119 by the user is not correct. Further, the image processing apparatus 602 notifies the installer 119 of the correct IP address, that is, the IP address 118 obtained by the IP address obtaining unit 616 (IP address on the first network 104 allocated to the image forming apparatus 603).

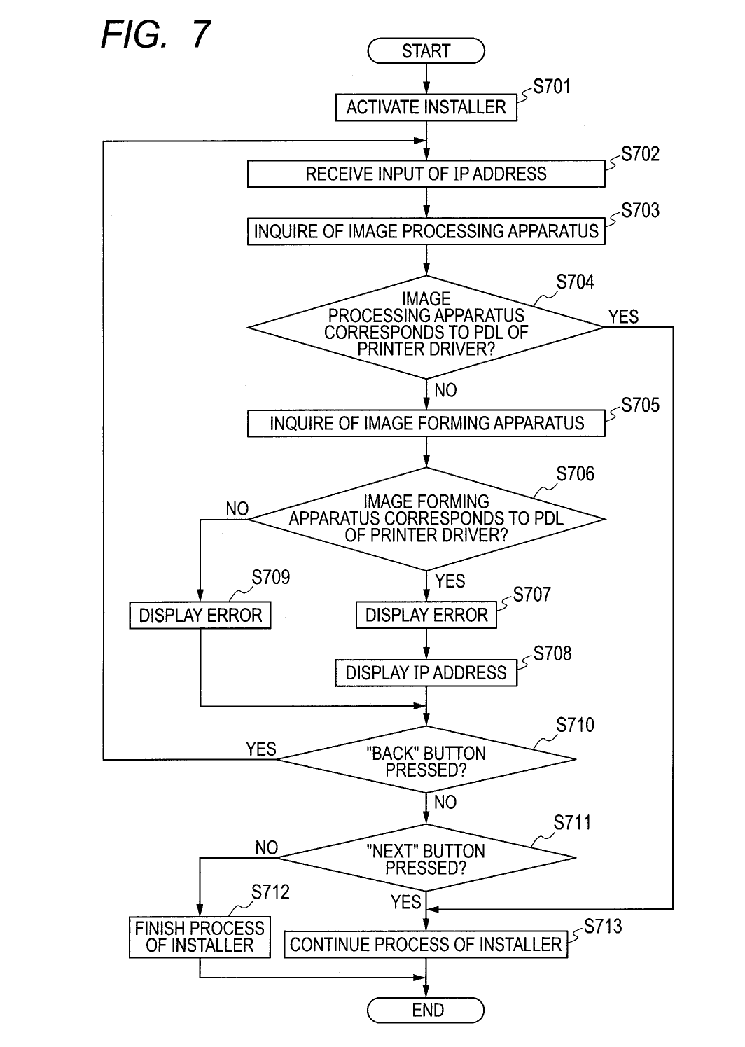

FIG. 7 is a flowchart for describing an example of the operation of the print system.

First, the installer 119 of the printer driver is activated (step S701).

Subsequently, the installer 119 displays the IP address input display screen 201 and receives such an operation that the user inputs the IP address (IP address 117 here) of a desired device corresponding to the printer driver to the IP address input display screen 201 (step S702).

Subsequently, the installer 119 executes a process for transmitting through the first network 104 the IP address 117 which was input in step S702 to the image processing apparatus 602 to which the IP address has been allocated. Together with the above process, in order to confirm whether or not the IP address input to the IP address input display screen 201 is correct, the installer 119 inquires about whether or not the image processing unit 109 corresponds to the page description language of the printer driver (step S703).

Subsequently, in response to the inquiry in step S703, the image processing apparatus 602 discriminates whether or not the image processing unit 109 corresponds to the page description language of the printer driver (step S704). As a result of the discrimination, if the image processing unit 109 of the image processing apparatus 602 corresponds to the page description language of the printer driver, the installer 119 continues the process for installing the printer driver (step S713).

When the image processing unit 109 of the image processing apparatus 602 does not correspond to the page description language of the printer driver, the processing routine advances to step S705. The PDL obtaining unit 615 inquires of the image forming apparatus 603 through, for example, the second network 105 about the page description language which can be processed by the image processing unit 113 of the image forming apparatus 603 (step S705).

Subsequently, based on a response to the inquiry in step S705, the PDL obtaining unit 615 discriminates whether or not the image processing unit 113 of the image forming apparatus 603 corresponds to the page description language of the printer driver (step S706). A response to this discrimination is made, for example, through the second network 105. As a result of the discrimination, if the image processing unit 113 of the image forming apparatus 603 corresponds to the page description language of the printer driver, the installer 119 displays the character string 302 onto the IP address warning display screen 301 (step S707). Subsequently, based on the response to the inquiry in step S705, the installer 119 displays the character string 303 onto the IP address warning display screen 301 (step S708). When the operation by the user is executed to the IP address warning display screen 301, the processing routine advances to step S710, which will be described hereinafter.

If it is determined in step S706 that the image processing unit 113 of the image forming apparatus 603 does not correspond to the page description language of the printer driver, step S709 follows. The installer 119 displays the IP address warning display screen 401 (character string 402) (step S709). When the operation by the user is executed to the IP address warning display screen 401, the processing routine advances to step S710.

In step S710, the installer 119 discriminates whether or not the Back button 304 on the IP address warning display screen 301 or the Back button 403 on the IP address warning display screen 401 has been pressed by the user. As a result of the discrimination, if the Back button 304 or 403 was pressed by the user, the processing routine is returned to step S702 and the installer 119 displays the IP address input display screen 201.

If the Back button 304 or 403 is not pressed by the user, step S711 follows. The installer 119 discriminates whether or not the Next button 305 on the IP address warning display screen 301 or the Next button 404 on the IP address warning display screen 401 has been pressed by the user (step S711). As a result of the discrimination, if the Next button 305 or 404 was pressed by the user, the installer 119 continues the process for installing the printer driver (step S713).

If the Next button 305 or 404 is not pressed by the user, this means that the Cancel button 306 on the IP address warning display screen 301 or the Cancel button 405 on the IP address warning display screen 401 has been pressed by the user. Therefore, the installer 119 stops (finishes) the process for installing the printer driver (step S712).

As mentioned above, even if the device (IP address) designated by the user is the image processing apparatus 602 as a target of the print control by the printer driver, an effect similar to that in the first embodiment is obtained.

The first embodiment and the second embodiment may be combined. That is, it is also possible to construct in such a manner that even if the device (IP address) designated by the user as a target of the print control by the printer driver is any one of the image processing apparatus and the image forming apparatus, the user can be notified of a fact that the IP address is improper.

In the embodiment, an example of the inquiring step is realized, for example, by executing the process of step S703. An example of the discriminating step is realized, for example, by executing the process of step S704. An example of the first obtaining step and the second obtaining step is realized, for example, by executing the process of step S705. An example of the second discriminating step is realized, for example, by executing the process of step S706. An example of the notifying step is realized, for example, by executing the process of steps S707 to S709.

### Third Embodiment

Subsequently, the third embodiment of the invention will be described. In the foregoing second embodiment, the case where the image processing apparatus 602 interprets the information from the client computer 101 (installer 119) or the image forming apparatus 103, thereafter, forms information and makes communication has been described as an example. On the other hand, in the third embodiment, a case where the image processing apparatus transfers as it is the information from the client computer 101 (installer 119) or the image forming apparatus will be described as an example. As mentioned above, in the first and third embodiments, a part of the process in the case where there is an error in the IP address which was input by the user differs mainly. Therefore, in the following description in the present embodiment, substantially the same portions as those in the first embodiment are designated by the same reference numerals shown in FIGS. 1 to 5 and their detailed description is omitted.

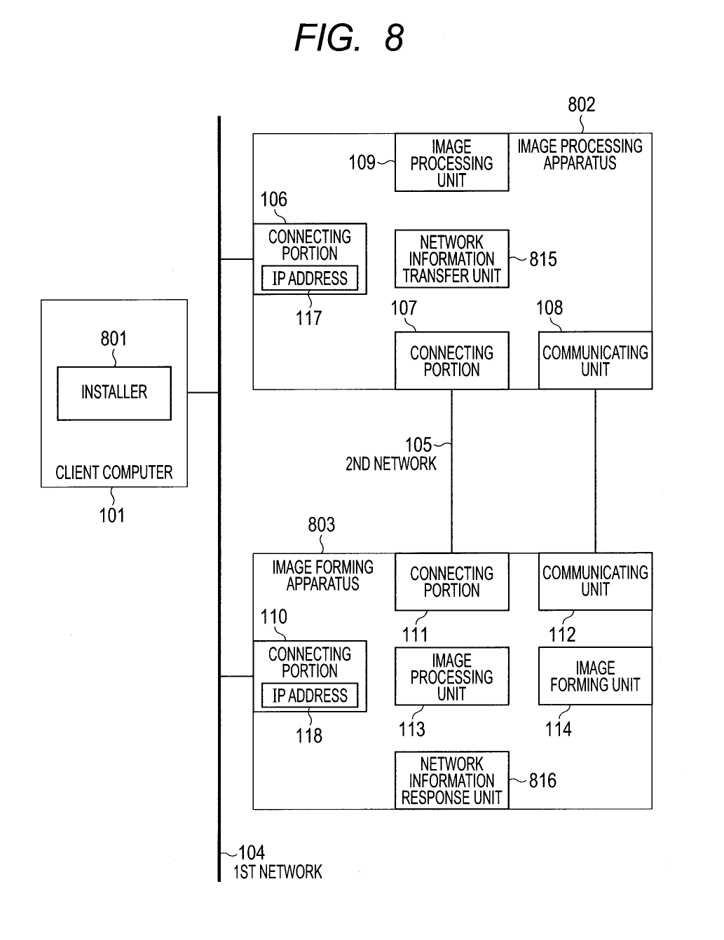

FIG. 8 is a diagram illustrating an example of a whole construction of the print system.

First, the print system is constructed in such a manner that the client computer 101, an image processing apparatus 802, and an image forming apparatus 803 are mutually connected through the first network 104. The image processing apparatus 802 is mutually connected to the image forming apparatus 803 through the second network 105.

The image processing apparatus 802 has the connecting portions 106 and 107, communicating unit 108, image processing unit 109, and a network information transfer unit 815. The embodiment will be described also with respect to a case where the image processing apparatus 802 is a print controller (print server) as an example.

The network information transfer unit 815 executes a process based on a program for transferring the information received from the first network 104 by the image processing apparatus 802 to the image forming apparatus 803 through the second network 105. The network information transfer unit 815 also executes a process based on a program for transferring the information received from the second network 105 by the image processing apparatus 802.

The image forming apparatus 803 has the connecting portions 110 and 111, communicating unit 112, image processing unit 113, image forming unit 114, and a network information response unit 816. The third embodiment will be also described with respect to a case where the image forming apparatus 803 is a printer as an example.

In response to a network packet request transferred from the network information transfer unit 815 of the image processing apparatus 802, the network information response unit 816 executes a process based on a program for making a response through the second network 105 and the first network 104. The network packet request is used to confirm whether or not the IP address which was input to the IP address input display screen 201 is correct. Specifically speaking, for example, a request of the information of the corresponding page description language in the image processing unit 113 of the image forming apparatus 803 and the information of the IP address on the first network 104 which is allocated to the image forming apparatus 803 is included in the network packet request. The network information response unit 816 responds to the request of the information of the page description language and the IP address. As mentioned above, the page description language indicates a language for describing a command for controlling a page printer.

The client computer 101 is an apparatus having the installer 119. As mentioned above, the installer 119 is a program for installing the printer driver for forming the print job including the page description language which can be processed by the image processing apparatus 802 or by the image forming apparatus 803 into the client computer 101.

It is assumed that in spite of a fact that the printer driver which the user intends to install is a printer driver for the image processing unit 113, the IP address 117 on the first network 104 allocated to the image processing apparatus 802 has been input to the installer 119. Thus, the image forming apparatus 803 notifies the client computer 101 of a message showing that the IP address 117 which was input to the installer 119 by the user is not correct. Further, the image forming apparatus 803 notifies the installer 119 of the correct IP address, that is, the IP address 118 obtained by the communication between the installer 119 and the network information response unit 816. In the embodiment, when the IP address input to the IP address input display screen 201 is wrong, any communication between the client computer 101 and the image forming apparatus 803 is made through the second network 105 and the image processing apparatus 802.

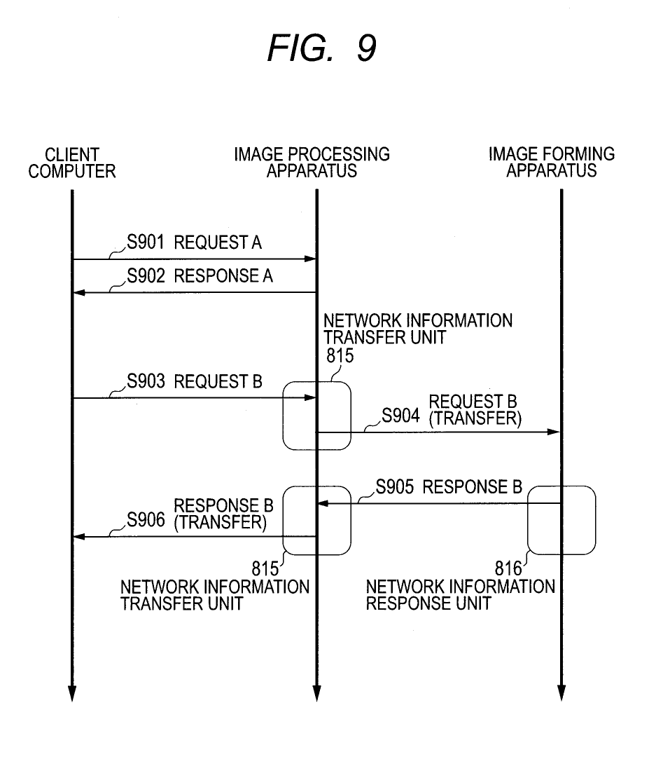

FIG. 9 is a diagram for describing in detail an example of the operation of the network information transfer unit 815 of the image processing apparatus 802.

First, a request A 901 from the client computer 101 and a response A 902 from the image processing apparatus 802 show an example of the ordinary network communication which is made between the client computer 101 and the image processing apparatus 802.

A unit which transfers a network packet to the image forming apparatus 803 by setting a request B 903 from the client computer 101 to a request B 904 is the network information transfer unit 815 of the image processing apparatus 802. A unit which makes a response B 905 to the request B 904 from the client computer 101 is the network information response unit 816 of the image forming apparatus 803 mentioned above. Similarly, a unit which transfers the network packet to the client computer 101 by setting the response B 905 to a response B 906 is also the network information transfer unit 815. Even if the request B 903 transmitted from the client computer 101 has contents which cannot be interpreted by the image processing apparatus 802, the request B 903 is transferred as it is to the image forming apparatus 103 by the network information transfer unit 815. Similarly, the response B 905 from the network information response unit 816 is also transferred as it is to the client computer 101. As mentioned above, it is one of features of the embodiment that the network information transfer unit 815 transfers the request B 903 and the response B 905 as they are and it is a valid point.

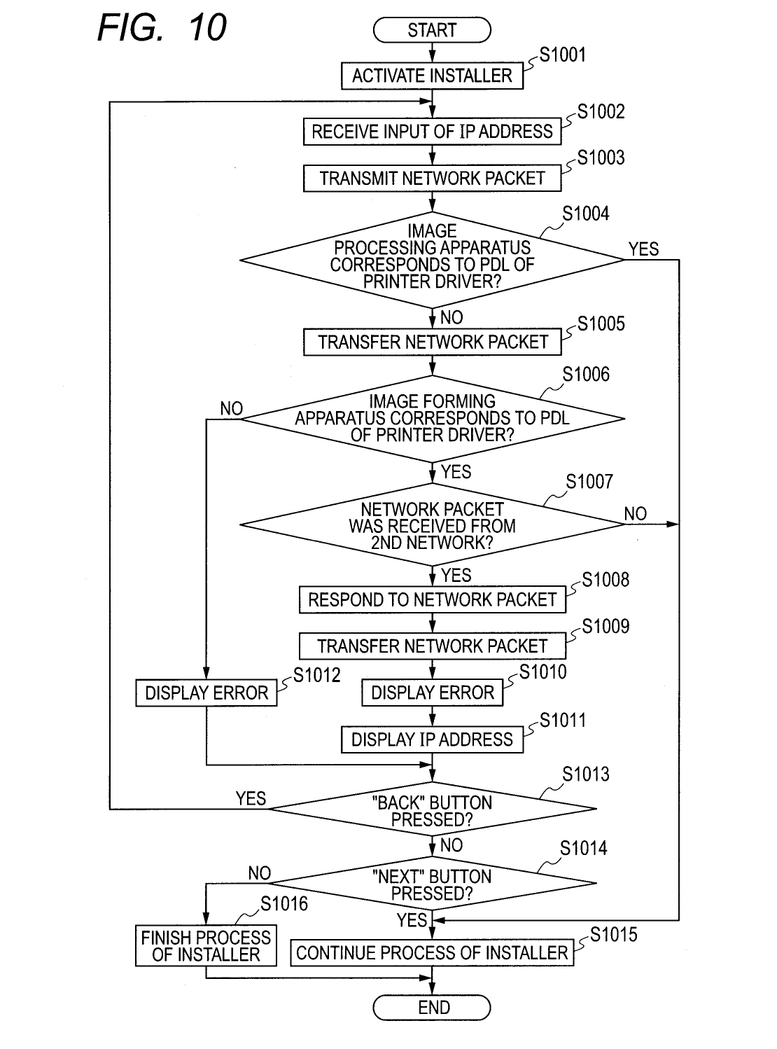

FIG. 10 is a flowchart for describing an example of the operation of the print system.

First, the installer 119 of the printer driver is activated (step S1001).

Subsequently, the installer 119 displays the IP address input display screen 201 and receives such an operation that the user inputs the IP address of a desired device corresponding to the printer driver to the IP address input display screen 201 (step S1002).

Subsequently, the installer 119 transmits the network packet request (request B 903) to the image processing apparatus 802 through the first network 104 based on the input IP address 117 (step S1003).

Subsequently, in response to the network packet request, the image processing apparatus 802 discriminates whether or not the image processing unit 109 of the image processing apparatus 802 corresponds to the page description language of the printer driver (step S1004). As a result of the discrimination, if the image processing unit 109 of the image processing apparatus 802 corresponds to the page description language of the printer driver, the installer 119 continues the process for installing the printer driver (step S1015). If the image processing unit 109 of the image processing apparatus 802 does not correspond to the page description language of the printer driver, the processing routine advances to step S1005. The network information transfer unit 815 transfers the network packet (request B 904) to the image forming apparatus 803 (step S1005).

Subsequently, based on the network packet (request B 904) transferred in step S1005, the image forming apparatus 803 discriminates whether or not the image processing unit 113 of the image forming apparatus 803 corresponds to the page description language of the printer driver (step S1006). As a result of the discrimination, if the image processing unit 113 of the image forming apparatus 803 does not correspond to the page description language of the printer driver, the processing routine advances to step S1012, which will be described hereinafter.

If the image processing unit 113 of the image forming apparatus 803 corresponds to the page description language of the printer driver, step S1007 follows. The network information response unit 816 discriminates whether or not the network packet transferred in step S1005 is a packet which has been received from the second network 105 (step S1007). As a result of the discrimination, if the network packet transferred in step S1005 is not the packet which has been received from the second network 105, the installer 119 continues the process for installing the printer driver (step S1015).

If the network packet transferred in step S1005 is the packet received from the second network 105, step S1007 follows. The network information response unit 816 responds to the request B 904 by the network packet through the second network 105 (response B 905, step S1008). The information of the corresponding page description language in the image processing unit 113 of the image forming apparatus 803 and the information of the IP address on the first network 104 which is allocated to the image forming apparatus 803 are included in this response.

Subsequently, the network information transfer unit 815 transfers the response from the network information response unit 816 to the installer 119 through the first network 104 (response B 906, step S1009).

Subsequently, the installer 119 displays the character string 302 onto the IP address warning display screen 301 (step S1010).

Subsequently, based on the network packet transferred in step S1009, the installer 119 displays the character string 303 onto the IP address warning display screen 301 (step S1011). When the operation by the user is executed to the IP address warning display screen 301, the processing routine advances to step S1012, which will be described hereinafter.

If it is determined in step S1006 that the image processing unit 113 of the image forming apparatus 803 does not correspond to the page description language of the printer driver, step S1012 follows. The installer 119 displays the IP address warning display screen 401 (character string 402) (step S1012). When the operation by the user is executed to the IP address warning display screen 401, the processing routine advances to step S1013.

In step S1013, the installer 119 discriminates whether or not the Back button 304 on the IP address warning display screen 301 or the Back button 403 on the IP address warning display screen 401 has been pressed by the user. As a result of the discrimination, if the Back button 304 or 403 was pressed by the user, the processing routine is returned to step S1002 and the installer 119 displays the IP address input display screen 201.

If the Back button 304 or 403 is not pressed by the user, step S1014 follows. The installer 119 discriminates whether or not the Next button 305 on the IP address warning display screen 301 or the Next button 404 on the IP address warning display screen 401 has been pressed by the user (step S1014). As a result of the discrimination, if the Next button 305 or 404 was pressed by the user, the installer 119 continues the process for installing the printer driver (step S1015).

If the Next button 305 or 404 is not pressed by the user, this means that the Cancel button 306 on the IP address warning display screen 301 or the Cancel button 405 on the IP address warning display screen 401 has been pressed by the user. Therefore, the installer 119 stops (finishes) the process for installing the printer driver (step S1016).

Even if the communication is made between the client computer 101 and the image forming apparatus 803 through the image processing apparatus 802 without modifying the information as mentioned above, an effect similar to that in the first embodiment is obtained.

In the embodiment, the case where the image processing apparatus 802 transfers the network packet transmitted from the client computer 101 and the image forming apparatus 803 has been described as an example. However, it is not always necessary to use such a construction. That is, the image forming apparatus 803 may transfer the network packet transmitted from the client computer 101 or the image processing apparatus 802. In such a case, the image forming apparatus 803 is allowed to have the function of the network information transfer unit 815 and the image processing apparatus 802 is allowed to have the function of the network information response unit 816.

In the embodiment, an example of the inquiring step is realized, for example, by executing the process of step S1003. An example of the discriminating step is realized, for example, by executing the process of step S1004. An example of the first transferring step is realized, for example, by executing the process of step S1005. An example of the second discriminating step is realized, for example, by executing the process of step S1006. An example of the obtaining step and the second obtaining step is realized, for example, by executing the process of step S1008. An example of the second transferring step is realized, for example, by executing the process of step S1009. An example of the notifying step is realized, for example, by executing the process of steps S1010 to S1012.

### Other Embodiments

Each of the units constructing the network system in the embodiment of the invention mentioned above and each step of the program installing method can be realized by a method whereby a program stored in a RAM, a ROM, or the like of the computer operates. The program and a computer-readable recording medium in which the program has been stored are incorporated in the invention.

The invention can be also realized by an embodiment, for example, as a system, an apparatus, a method, a program, a storage medium, or the like. Specifically speaking, the invention can be also applied to a system constructed by a plurality of apparatuses or may be applied to an apparatus constructed by one device.

The invention incorporates a case where a program of software for realizing the functions of the embodiment mentioned above (program corresponding to the flowcharts illustrated in FIGS. 5, 7, and 10 in the embodiment) is supplied to a system or an apparatus. The invention also incorporates a case where the functions of the embodiment mentioned above are accomplished by a construction in which the computer of the system or apparatus reads out codes of the supplied program and executes them.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-113009, filed May 7, 2009, which is hereby incorporated by reference herein in its entirety.

What is claimed is:

1. A program installing method of installing a program for controlling an operation of one of a first apparatus and a second apparatus connected through a local network into an information processing apparatus which communicates with the first apparatus and the second apparatus through a global network different from the local network, the method comprising:
an inquiring step of inquiring of the first apparatus having an address designated by a user as a control target by the program about whether or not the address is correct from the information processing apparatus;
a discriminating step of discriminating whether or not a program to be installed can control the first apparatus in response to the inquiry; and
a notifying step of, if it is discriminated in the discriminating step that the program cannot control the first apparatus, notifying that the designated address is wrong based on information indicative of a discrimination result.

2. A method according to claim 1, further comprising:
an obtaining step of, if it is discriminated in the discriminating step that the program cannot control the first apparatus, obtaining information regarding contents which can be processed by the second apparatus under control by the program from the second apparatus; and
a second discriminating step of discriminating whether or not the program can control the second apparatus based on the information obtained in the obtaining step,
wherein in the notifying step, according to a result of the discrimination in the second discriminating step, the user is notified of a fact that the designated address is wrong.

3. A method according to claim 1, further comprising a second obtaining step of, if it is discriminated in the discriminating step that the program cannot control the first apparatus, obtaining information regarding an address of the second apparatus from the second apparatus,
wherein in the notifying step, if it is discriminated in the second discriminating step that the program installed can control the second apparatus, the address of the second apparatus is further notified based on the information obtained in the second obtaining step.

4. A method according to claim 2, further comprising:
a first transferring step of, if it is discriminated in the discriminating step that the program installed cannot control the first apparatus, executing a process for transferring the inquiry made in the inquiring step as it is from the first apparatus to the second apparatus; and
a second transferring step of executing a process for transferring the information obtained in the obtaining step and the second obtaining step as they are from the first apparatus to the information processing apparatus,
wherein in the second discriminating step, whether or not the program can control the second apparatus is discriminated based on the information transferred in the second transferring step.

5. A method according to claim 1, wherein the first apparatus and the second apparatus are one of an image forming apparatus for forming an image based on image data and an image processing apparatus for transmitting the image data to the image forming apparatus, and wherein the program is a printer driver.

6. A network system which has an information processing apparatus having an installer for installing a program and a first apparatus and a second apparatus for communicating with the information processing apparatus through a global network and in which the first apparatus and the second apparatus are connected through a local network, the system comprising:
an inquiring unit constructed to inquire of the first apparatus having an address designated by a user as a control target by the program about whether or not the address is correct from the information processing apparatus;
a discriminating unit constructed to discriminate whether or not a program to be installed can control the first apparatus in response to the inquiry made by the inquiring unit; and
a notifying unit constructed to, if the discriminating unit discriminates that the program cannot control the first apparatus, notify that the designated address is wrong based on information indicative of a discrimination result.

7. A system according to claim 6, further comprising:
an obtaining unit constructed to, if it the discriminating unit discriminates that the program cannot control the first apparatus, obtain information regarding contents which can be processed by the second apparatus under control by the program from the second apparatus; and
a second discriminating unit constructed to discriminate whether or not the program can control the second apparatus based on the information obtained by the obtaining unit,
wherein according to a result of the discrimination by the second discriminating unit, the notifying unit notifies the user of a fact that the designated address is wrong.

8. A system according to claim 6, further comprising a second obtaining unit constructed to, if the discriminating unit discriminates that the program cannot control the first apparatus, obtain information regarding an address of the second apparatus from the second apparatus,
wherein if the second discriminating unit discriminates that the program can control the second apparatus, the notifying unit further notifies of the address of the second apparatus based on the information obtained by the second obtaining unit.

9. A system according to claim 7, further comprising:
a first transferring unit constructed to, if the discriminating unit discriminates that the program cannot control the first apparatus, execute a process for transferring the inquiry made by the inquiring unit as it is from the first apparatus to the second apparatus; and
a second transferring unit constructed to execute a process for transferring the information obtained by the obtaining unit and the second obtaining unit as they are from the first apparatus to the information processing apparatus,
wherein the second discriminating unit discriminates whether or not the program can control the second apparatus based on the information transferred by the second transferring unit.

10. A computer-readable storage medium which stores a control program for allowing a computer to execute the method according to claim 1.
